(19) United States
(12) Patent Application Publication
(10) Pub. No.: US 2003/0210265 A1
(43) Pub. Date: Nov. 13, 2003

(54) Interactive chat messaging

(76) Inventor: Nadav Y. Haimberg, Oviedo, FL (US)

Correspondence Address: Kevin T. Cuenot, Akerman, Senterfitt & Eidson, P.A., Post Office Box 3188, West Palm Beach, FL, 33402-3188, US

(21) Appl. No.: 10/143,660

(22) Filed: May 10, 2002

(51) Int. Cl. G09G 5/00

(52) U.S. Cl. 345/758; 345/835

(57) ABSTRACT

In an electronic communication system, a method of exchanging messages over a computer network can include detecting a presence of communication session participants on the computer network. The communication session participants can be included within an authorized list of potential communication session participants. Detected communication session participants can be represented as graphical activatable icons arranged throughout a pictorial environment. The graphical activatable icons can be dynamically animated responsive to events associated with the communication session participants.

### BACKGROUND OF THE INVENTION

1. Technical Field

The invention relates to the field of communications, and more particularly, to instant messaging performed over a communications network.

2. Description of the Related Art

Instant messaging systems, or so called chat systems, allow registered instant messaging system users to send messages to other registered instant messaging system users over computer communications networks such as the Internet. Instant messaging systems typically require one or more instant messaging servers and associated instant messaging clients through which users gain access to the instant messaging system. Through the various user interfaces of the instant messaging clients, users can access instant messaging functions such as composing messages, sending messages, viewing received messages, and the like.

To provide users with access to the various instant messaging functions, typical instant messaging clients incorporate several user interfaces, each intended to perform particular functions. One common user interface provided by most conventional instant messaging clients is a window for displaying an authorized listing of registered users having a presence online, commonly referred to as a “contact list” or “buddy list”. This user interface is typically provided as a textual listing of users. Although the listing can be organized in a hierarchical fashion and include various status icons indicating whether a user is available or busy, the listing itself has been limited to a textual listing of user names, screen names, or electronic mail addresses.

The selection of a user's text-based identifier or screen name listed within the contact list causes the instant messaging client to open a messaging window for communicating with the user associated with the selected screen name. In the event that multiple screen names are selected from the contact list, conventional instant messaging clients open a separate messaging window and corresponding instant messaging session for each selected screen name. Similarly, should incoming instant messages from instant messaging participants be received by the instant messaging client, a different messaging window and instant message session for communicating with each instant messaging participant is opened.

Opening a separate messaging window for each instant message session and/or instant messaging participant does enable a user to conduct several instant messaging sessions with different instant messaging participants. This technique, however, also consumes a significant amount of space on a display. In consequence, users may find it difficult to work with other applications while participating in multiple chat sessions as the user's view of underlying application windows is obscured by multiple open messaging windows. Also, to remain an active participant in each ongoing instant messaging session, the user must direct his or her attention to various messaging interfaces strewn about the display as well as navigate among the open messaging windows to view and send instant messages.

### SUMMARY OF THE INVENTION

The invention disclosed herein provides an intuitive interface through which users can communicate with one another. In particular, the present invention provides a unique three-dimensional environment that facilitates communications between multiple participants. Additionally, the present invention provides a dynamic messaging interface through which a user can conduct several different communication sessions with one or more participants. The messaging interface can dynamically display messages corresponding to any one of several ongoing communications sessions or participants responsive to particular events. In consequence, the present invention allows a user to participate in several communication sessions using a single messaging interface, thereby utilizing less display area than conventional communication clients and/or systems.

One aspect of the present invention can include a method of exchanging messages over a computer communication network using an electronic communications system such as a chat client. The method can include detecting a presence of communication session participants on the computer network. The communication session participants can be included within an authorized list of potential communication session participants. Detected communication session participants can be represented as graphical activatable icons arranged throughout a pictorial environment. Notably, the pictorial environment can be a three-dimensional environment.

The activatable icons can be dynamically animated responsive to events associated with the communication session participants. The activatable icons can be dynamically animated responsive to an event such as a change in a status of the presence of one of the communication session participants on the computer network. For example, the event can be one of the communication session participants logging onto the computer network, one of the communications session participants logging off of the computer network, receiving a communication from one of the communication session participants, and/or sending a communication to one of the communication session participants. The activatable icons also can be dynamically animated responsive to a communication session participant being idle where a communication from the communication session participant has not been received for a predetermined period of time, one of the communication session participants selecting an online emotional state, and/or one of the communication session participants selecting an online status indicator.

Responsive to a selection of one of the graphical activatable icons, a messaging window of the electronic communication system can be focused for communicating with one of the detected communication session participants represented by the selected graphical activatable icon. The method further can include locating an activatable icon utility proximate to the selected activatable icon. The activatable icon utility and the pictorial environment can be contained within a first display window of the electronic communication system which is distinct from the messaging window of the electronic communication system. A graphical user interface for receiving message text to be sent to a communication session participant can be displayed as an attachment to a utility bar of an operating system.

Another aspect of the present invention can include a method of chat communication including receiving chat messages associated with multiple chat sessions and providing activatable icons for each of the chat sessions. Chat messages associated with a selected one of the chat sessions can be identified and particular ones of the identified chat messages can be displayed within a messaging portion of a chat client interface. The identifying and displaying step can be responsive to receiving a chat message associated with the selected chat session. Accordingly, the activatable icon representing the selected chat session can be visually distinguished from other ones of the activatable icons. Still, the identifying step and the displaying step can be responsive to a user selection of an activatable icon representing the selected chat session. The method further can include, responsive to a selection of another one of the activatable icons, displaying within the messaging portion of the chat client only those chat messages associated with the chat session represented by the selected other one of the activatable icons.

Another aspect of the present invention can include an electronic communication system, such as a chat client, configured to detect a presence of communication session participants on a network, wherein the communication session participants are included within an authorized list of potential communication session participants. The electronic communication system further can be configured to represent detected communication session participants as graphical activatable icons arranged throughout a three-dimensional environment, and to dynamically animate the graphical activatable icons responsive to detected events associated with the communication session participants. Responsive to a selection of one of the graphical activatable icons, the electronic communication system also can be configured to focus a messaging window of the electronic communication system for communicating with one of the detected communication session participants represented by the selected graphical activatable icon.

Yet another aspect of the present invention can include a graphical user interface for an electronic communication system such as a chat client. The graphical user interface can include a single messaging display area having a plurality of selectable tabs, wherein each tab is associated with a particular ongoing chat session. Selection of any one of the tabs can cause the messaging display area to display only chat communications associated with the ongoing chat session represented by the selected tab.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a schematic diagram illustrating a system for chat communication in accordance with the inventive arrangements disclosed herein.

FIG. 2 is a schematic diagram illustrating a graphical user interface for use with the system of FIG. 1.

FIG. 3 is a schematic diagram illustrating one aspect of the graphical user interface of FIG. 2.

FIG. 4 is a schematic diagram illustrating another aspect of the graphical user interface of FIG. 2.

FIG. 5 is a schematic diagram illustrating another graphical user interface for use with the present invention.

FIG. 6 is a flow diagram illustrating a method of chat communication in accordance with the inventive arrangements disclosed herein.

### DETAILED DESCRIPTION OF THE INVENTION

The invention disclosed herein provides an intuitive interface through which users can communicate with one another. In particular, the present invention provides a unique three-dimensional environment that facilitates instant messaging communications, or so called chat communications, between multiple users, as well as a dynamic messaging interface through which a user can conduct several different chat sessions with one or more communication session participants. The messaging interface can dynamically display chat messages associated with any one of several ongoing chat sessions responsive to various events.

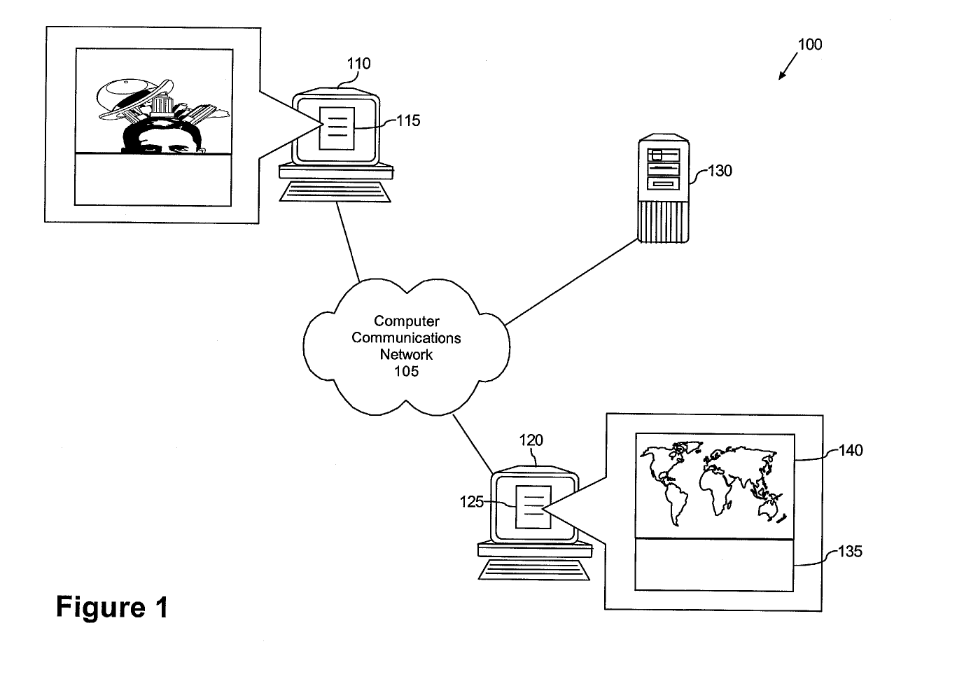

FIG. 1 is a schematic diagram illustrating a system 100 for chat communication in accordance with the inventive arrangements disclosed herein. As shown in FIG. 1, the system 100 can include computer systems 110 and 120, a chat server 130, each of which being communicatively linked via a computer communications network 105. The chat server 130 can facilitate the distribution of chat messages between computer systems 110 and 120 via each computer system's respective chat client 115 and 125. For example, the chat server 130 can include a registry of participating users (chat participants) to which chat messages can be directed from other chat participants.

The computer communications network 105 can include any of a variety of computer networks such as local area networks, wide area networks, or the Internet, such that the chat clients 115 and 125, for example, can initiate a TCP/IP connection with the chat server 130. Accordingly, users can log on to the chat server 130 through their respective chat clients 115 and 125 to establish a presence on the network, or a presence online. The chat clients 115 and 125 can provide the chat server 130 with information such as an IP address and port number allocated to each chat client. Having established a presence online with the chat server 130, the chat clients 115 and 125 can send and receive instant messages (hereafter chat messages) to one another via the chat server 130. Notably, any of a variety of instant messaging protocols, including both proprietary and developing or draft instant messaging protocol standards as set forth by the Internet Engineering Task Force, can be used to facilitate communications between the chat clients 115 and 125.

The chat clients 115 and 125 can include several display areas. For example, chat client 125 can include two windows 135 and 140. The chat client 125 can be configured to display windows 135 and 140 proximate to one another as shown such that display windows 135 and 140 appear as a single unified interface. Still, windows 135 and 140 can be displayed independently of one another, and thus, can be moved about on a display and minimized, or hidden from view, independently of the other window. Window 140 can display pictorial environments representing various scenes. The scenes can be displayed as backgrounds within window 140. The window 140 also can display pictorial representations of other chat participants having a presence online. According to one embodiment of the present invention, the pictorial environments included in window 140 can be three-dimensional environments. For example, the Window 135 can function as a messaging interface for displaying incoming and outgoing chat messages.

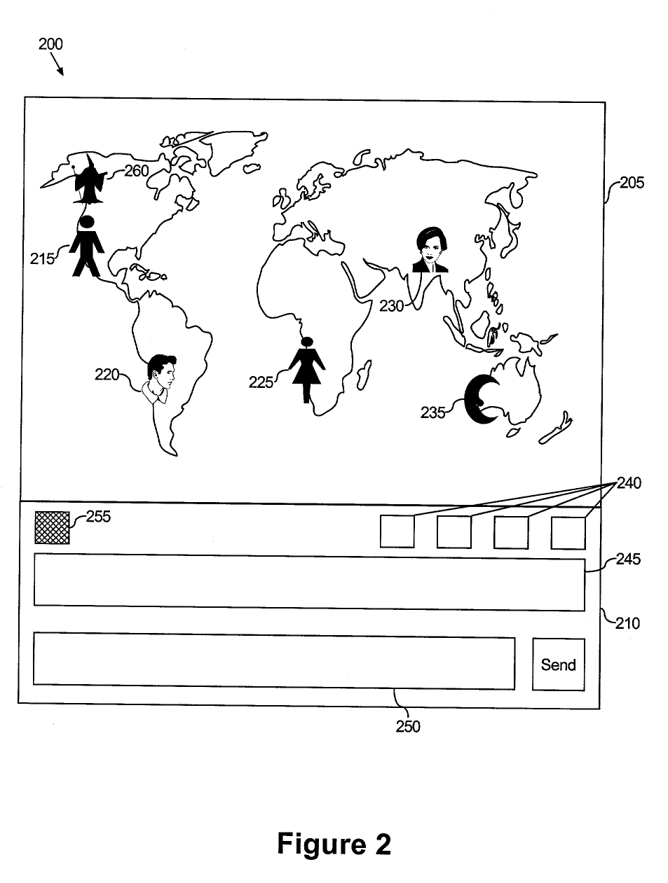

FIG. 2 is a schematic diagram illustrating a graphical user interface (GUI) 200 for use with the system of FIG. 1. As shown in FIG. 2, the GUI 200 can include a first display area 205 and a second display area 210. The display area 205 can display various pictorial environments or backgrounds, including three-dimensional views, wherein users specified within an authorized list such as a contact list can be depicted using pictorial illustrations functioning as activatable icons. The pictorial illustrations (hereafter referred to as activatable icons) can be any static or animated image generated from instructions, programs, and/or algorithms which can generate two or three-dimensional models. The activatable icons can be visual proxies, whether abstract, imaginary, or based on real life objects or occurrences, for potential chat session participants included in the authorized list. The activatable icons can be dynamically animated to reflect various operating conditions of the chat client or to reflect detected events associated with the chat participant represented by the activatable icon. The activatable icons and the three-dimensional views can be downloaded, and therefore, exchanged among different chat session participants.

Thus, activatable icons 215, 220, 225, 230, and 235 can represent potential chat session participants specified within a contact list used by the chat client. The contact list as well as the associated activatable icons 215-235 can be stored locally with the chat client, or can be accessed from the chat server. Regardless, the inclusion of the activatable icons 215-235 within the display area 205 indicates that the chat participants represented by the activatable icons 215-235 have a presence online, or have logged onto the chat system. Accordingly, as chat participants specified in the authorized list log on and off of a computer network, the activatable icon representation of that chat participant also can be inserted into or removed from the three-dimensional environment.

As mentioned, the activatable icon 215-235 can be static or animated representations of potential chat session participants. Each of the activatable icons can be animated to reflect various events. For example, the activatable icons can be dynamically animated responsive to events such as receiving a communication from the chat participant represented by the activatable icon, chat participants logging on or off of a computer network, and/or the chat participant being idle for a predetermined time period. The activatable icons also can reflect events such as a chat participant changing an emotional state. In that case, the activatable icon representing the chat participant can be animated to reflect the chat participant's selected emotion. For example, the activatable icon can be made to appear happy, sad, angry, or the like. Similarly, the activatable icons can be animated to reflect other states such as busy, on the phone, away from the desk, on vacation, idle, and the like.

Notably, although the activatable icons can be animated using a series of static images, the activatable icons also can be animated to model continual movement, emotion, and states rather beyond merely changing an image from a sad image to a happy image. For example, an activatable icon shown as a sprite or character can be made to brood, pick up a telephone, smile, laugh, sleep, or the like. The activatable icons can reflect movement. The activatable icons, for example when implemented as three-dimensional on-screen entities, can be generated using three-dimensional animation techniques including but not limited to key frames, inverse kinematics, or any other suitable three-dimensional modeling or rendering technique. Display area 210 is a messaging section of the GUI 200 which provides functionality such as sending and/or receiving chat messages, files, and uniform resource locators (URLs), and can provide log in, log off, selection of a particular chat participant as a recipient of a chat message, as well as access to various administrative features including adding, editing, or deleting chat participants from a contact list. For example, icons 240 can provide users access to administrative functions such as attaching files, log on, log off, and the like. Field 245 can display instant messages being passed between the chat client of the present invention and one or more other chat clients participating in a chat session. Field 250 can be used to compose instant messages to be sent to other chat clients. Icon 255 can be used to display a table or grid of activatable icons representing chat participants specified in a list of contacts.

Notably, the table or grid of activatable icons displayed responsive to activation of icon 255 can be limited to only those contacts who have a presence online.

The focus of the chat client can be altered by selecting various icons 215-235 from the pictorial environment shown in display area 205. For example, when icon 215 is selected, the focus of display area 210 can dynamically shift to establishing a chat session with the chat participant represented by icon 215, or to an established chat session with the chat participant represented by icon 215. Thus, a chat message composed in field 250 would be directed to the chat participant represented by icon 215. Notably, the focus of field 245 also can be directed to a chat session involving the chat participant represented by icon 215. In illustration, the chat client can buffer received chat messages from one or more of the chat participants represented by icons 215-235. Upon selection of icon 215, for example, only those chat messages received from, or sent to the chat participant represented by icon 215, or only those messages associated with a chat session involving the chat participant represented by icon 215 can be displayed. In one embodiment of the present invention, the focus of display area 210 can dynamically change according to the sender of a received chat message.

Particular functions of the chat client also can be accessed through a utility icon 260 shown in display area 205. The utility icon 260, in this case a pictorial illustration of a wizard, can be an activatable icon through which users also can access the aforementioned functions described with reference to display area 250 and icons 240. This provides users with a measure of convenience as users can choose to interact with each display areas 205 or 210 independently of the other. The utility icon 260 can be displayed proximate to an icon representing the chat participant to which the chat client is currently focused. For example, in this case the utility icon 260 is displayed proximate to icon 215 representing the chat participant to which the chat client is focused. In addition to distinguishing icon 215 from the other icons 220, 225, 230, and 235 by locating the utility icon 260 proximately thereto, icon 215 also can be highlighted.

It should be appreciated by those skilled in the art that additional user interfaces can be included. For example, the display section 205 can accompany other conventional chat client user interfaces such as text-based contact lists, or can be provided in the alternative to such interfaces.

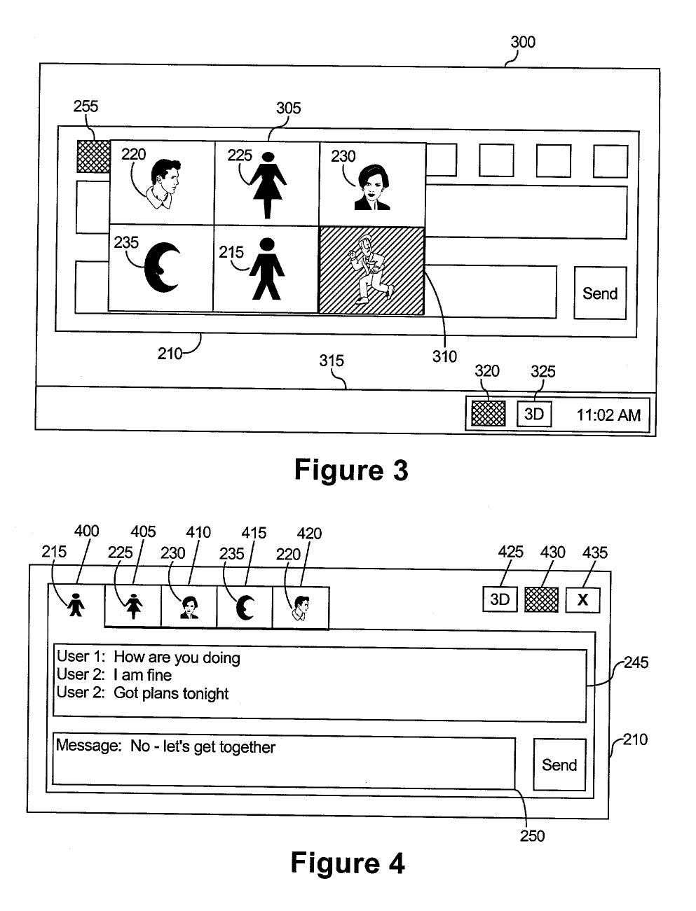

FIG. 3 is a schematic diagram illustrating one aspect of the display portion 210 of GUI 200 of FIG. 2. As shown in FIG. 3, the display portion 210 is displayed upon an exemplary display screen 300. Responsive to a selection of icon 255, a menu 305 of selectable images can be displayed. The images can be activatable icons representing chat participants specified in a contact list of the chat client. Depending upon the configuration of the chat client, the activatable icons of the menu 305 may or may not be limited to only those chat participants specified in the contact list and having an online presence at the time the icon 255 is activated. In this case, for example, the activatable icons 215, 220, 225, 230, and 235 of the menu 305 correspond to the icons shown in the display portion 205 of FIG. 2. Notably, an activatable icon 310 also has been included. The activatable icon 310 has been highlighted indicating that although the chat participant represented by activatable icon 310 is listed in the contact list, the chat participant is not presently online.

The exemplary display screen 300 can include a utility bar 315. The utility bar 315, sometimes referred to as a “task bar”, is typically provided by the operating system upon which the chat client executes. According to one embodiment of the present invention, upon execution, one or more activatable icons such as icons 320 and 325 can be included or placed on the utility bar 315. The icons 320 and 325 can be programmed to perform a variety of functions. For example, icon 325 can be a toggle switch which can cause the display portion 205 to be displayed upon display screen 300 or be hidden from view. In this case, icon 325 has been set to hide display portion 205 from view. Notably, an additional icon can be provided for maximizing or minimizing the display portion 210 as well.

Icon 320 can be programmed with the same functionality as utility icon 255. Thus, in situations where the display portion 210 has been minimized and is not shown upon the display screen 300, a user can initiate a chat session directed to a chat participant included within a contact list. Selection of icon 320 can cause a menu similar to that of menu 305 to appear. Again, the activatable icons shown within the menu displayed responsive to activation of icon 325 can include all contacts of a list, particular groupings of contacts, or can be limited to only those contacts presently online. In the case where contacts are shown regardless of having a presence online, the activatable icons representing online chat participants can be visually distinguished from activatable icons representing offline chat participants.

FIG. 4 is a schematic diagram illustrating another aspect of the of the display portion 210 of FIG. 2. In particular, FIG. 4 illustrates the manner in which the display portion 210 can dynamically adapt to any of a variety of ongoing chat sessions. According to this embodiment of the present invention, display portion 210 can be configured to include several tab portions 400, 405, 410, 415, and 420, each corresponding to a chat session currently in progress. Thus, a user can carry on multiple chat sessions, each of which involving one or more chat participants, through a single messaging window such as display portion 210 of the present invention.

Each of the tabs 400-420 can correspond different ongoing chat sessions with various chat participants represented by icons 215-235 respectively. If more than one other chat participant is involved in a particular chat session, then any one of the icons representing the chat participants of a particular chat session can be included on a tab.

For example the icon representing a first chat participant to join a chat session can be shown. Alternatively, several icons representing each chat participant of a given chat session can be included on a tab. In any case, to focus the display portion 210 on a particular chat session or chat participant, the tab corresponding to that chat session or chat participant, as indicated by the activatable icon displayed on the desired tab, can be selected. As shown in FIG. 4, tab 400 has been selected. Accordingly, field 245 can display chat communications exchanged between the chat participant represented by icon 215 and the chat client user of the present invention. Similarly, the text message shown in field 250 will be directed to the chat participant represented by icon 215. To change the focus to any of the chat participants represented by the tabs 400 through 420, one need only select the corresponding tab. Notably, should a chat session include more text messages that can be shown within field 245, then selected messages, such as the most recently exchanged messages of the session, can be displayed. Still, suitable field navigation controls such as scroll bars can be provided.

As mentioned, the tabs can represent ongoing chat sessions conducted with the chat client. Still, other embodiments of the display portion 210 can be provided. For example, similar to the menu of contacts 305 of FIG. 3, the icons displayed as tabs can include icons representing all contacts of a list, particular groupings of contacts, or can be limited to only those contacts presently online. Additional icon utilities such as icons 425, 430, and 435 also can be provided. Icon 425, for example, can be a toggle switch causing the display portion 205 of FIG. 2 to be displayed or hidden from view. The icon 430 can provide access to a contact list as described with reference to icon utility 255. Selection of icon 435 can terminate the chat client execution.

Although the focus of display area 210 can be changed upon selection of one of the tabs 400-420, through the icon 430, or by selecting an activatable icon from display area 205 (not shown), the focus of display area 210 can change dynamically based upon the most recently received chat message. That is, if the display area 210 is focused on the chat participant represented by icon 215, and a chat message is received from the chat participant represented by icon 220, the focus of display area 210 can be changed to display chat communications between the user of the present invention and the chat participant represented by icon 220. This feature, however, may be activated or deactivated according to user preference. Regardless, the tabs corresponding to chat sessions not currently in focus, but which have received new messages, can be made to blink or otherwise be visually distinguished from other ones of the tabs 400-420.

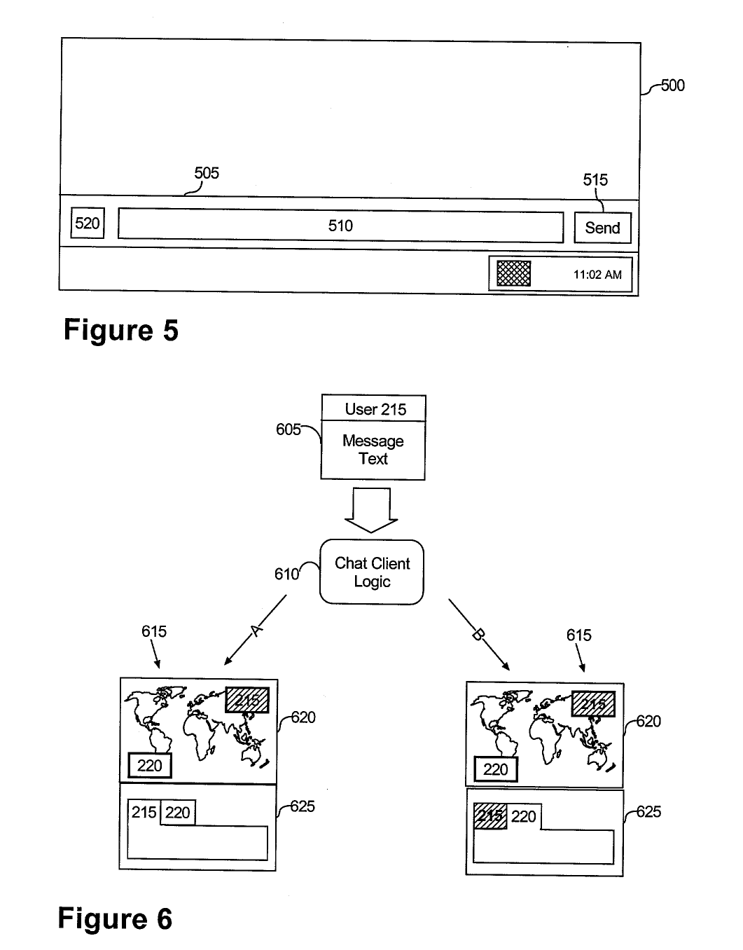

FIG. 5 is a schematic diagram illustrating another aspect of the present invention. As shown in FIG. 5, an exemplary display screen 500 includes a docking component 505 of the chat client interface disclosed herein. The docking component 505 can be displayed in place of the chat client messaging sections previously discussed, or in place of the message authoring portions of the messaging section. The docking component option can be selected from a button provided in any of the aforementioned graphical user interfaces or through a program configuration utility. The docking component further can be toggled on or off according to user preference. As shown, the docking component 505 can be located above a task bar or utility bar of an operating system. If the task bar is located at the top of a display screen, however, the docking component 505 can be located beneath the task bar. Although the docking component 505 is depicted as extending the full length of the display screen and having a rectangular shape, those skilled in the art will recognize that the docking component 505 can take on any of a variety of shapes and/or sizes.

In any case, the docking portion 505 can include a field 510 for typing outgoing message text. An activatable icon 515 can be included for accessing a contact list. The activatable icon 515 can function in similar fashion to button 255 of FIG. 3, and thus can be used to direct message text typed into field 510 to various chat participants. The docking portion 505 also can include a send button for sending the text message input into field 510.

FIG. 6 is a flow diagram illustrating a method of chat communication in accordance with the inventive arrangements disclosed herein. As shown, a chat message 605 sent from chat participant 215 can be received and processed by chat client logic 610. The chat client logic can identify the sender, in this case chat participant 215 from the header information included in the received chat message 605. Taking path A, according to one embodiment of the present invention, the GUI 615 can be dynamically updated to reflect that the received chat message was from chat participant 215. For example, if tab 215 was previously in focus, that is, the messaging section 625 already displayed communications with chat participant 215, then tab 215 can remain in focus. If, however, tab 220 was in focus and the messaging section 625 displayed communications with chat participant 220, then tab 215 can be brought into focus such that messaging section 620 displays only messages sent to, or received from chat participant 215. Notably, in display section 620, the activatable icon 215 representing chat participant 215 can be highlighted. The activatable icon 215 further can be animated. For example the activatable icon 215 can appear to knock, ring a doorbell, or otherwise provide an indication that the chat participant 215 represented by the activatable icon 215 has sent a message. Additionally, as previously mentioned, an icon utility (not shown) can be located proximate to the icon 215 in the display section 620 indicating that the chat participant represented by icon 215 is currently in focus.

Taking path B, according to another embodiment of the present invention, the GUI 615 can be updated subsequent to processing the received chat message 605, but does not dynamically shift focus. Thus, in the case wherein tab 220 is in focus, subsequent to receiving chat message 605 from chat participant 215, tab 215 can be visually distinguished from tab 220 in messaging section 625. For example, tab 215 in messaging section 625 can be highlighted or made to blink. Still, activatable icon 215 in display section 620 also can be made to blink, be animated, or otherwise be visually distinguished from other displayed icons representing online chat participants.

Although the invention disclosed herein has been described with reference to chat or instant messaging systems and clients, those skilled in the art will recognize that aspects of the present invention also can be used with regard to any of a variety of messaging systems which are capable of supporting the various graphical user interfaces disclosed herein. For example, within electronic mail systems or voice communications systems including voice instant messaging or other systems utilizing voice-over IP, persons included in an authorized list can be represented within various three-dimensional environments with dynamically animated activatable icons. Accordingly, electronic mail clients and voice chat clients also can be configured to display a three-dimensional environment wherein communication participants can be modeled as animated activatable icons. These animated activatable icons also can respond to various events.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. In an electronic communication system, a method of exchanging messages over a computer network comprising:
detecting a presence of communication session participants on said computer network, wherein said communication session participants are included within an authorized list of potential communication session participants;
representing detected communication session participants as graphical activatable icons arranged throughout a pictorial environment; and
dynamically animating said graphical activatable icons responsive to events associated with said communication session participants.

2. The method of claim 1, wherein said electronic communication system is a chat client.

3. The method of claim 2, wherein said event is a change in a status of said presence of one of said communication session participants on said computer network.

4. The method of claim 3, wherein said event is selected from the group consisting of one of said communication session participants logging onto said computer network, one of said communications session participants logging off of said computer network, receiving a communication from one of said communication session participants, and sending a communication to one of said communication session participants.

5. The method of claim 3, wherein said event is selected from the group consisting of not receiving a communication from one of said communication session participants for a predetermined period of time, one of said communication session participants selecting an online emotional state, and one of said communication session participants selecting an online status indicator.

6. The method of claim 2, wherein said pictorial environment is a three-dimensional environment.

7. The method of claim 6, further comprising:
responsive to a selection of one of said graphical activatable icons, focusing a messaging window of said chat client for communicating with one of said detected chat session participants represented by said selected graphical activatable icon.

8. The method of claim 7, further comprising:
displaying a graphical user interface, for receiving message text to be sent to one of said communication session participants, as an attachment to a utility bar of an operating system.

9. The method of claim 8, further comprising:
locating an activatable icon utility proximate to said selected activatable icon.

10. The method of claim 9, wherein said activatable icon utility and said pictorial environment are contained within a first display window of said chat client which is distinct from said messaging window of said chat client.

11 A method of chat communication comprising:
receiving chat messages associated with a plurality of chat sessions;
identifying chat messages associated with a selected one of said plurality of chat sessions; and
displaying said selected chat session within a messaging portion of a chat client interface.

12. The method of claim 11, wherein said identifying step and said displaying step are responsive to receiving a chat message associated with said selected chat session.

13. The method of claim 12, further comprising:
providing activatable icons for each of said plurality of chat sessions; and
visually distinguishing one of said activatable icons representing said selected chat session from other ones of said activatable icons.

14. The method of claim 11, further comprising:
providing activatable icons for each of said plurality of chat sessions, wherein said identifying step and said displaying step are responsive to a user selection of one of said activatable icons representing said selected chat session.

15. The method of claim 11, further comprising:
responsive to a selection of another one of said activatable icons, displaying within said messaging portion of said chat client only those chat messages associated with said chat session represented by said selected another one of said activatable icons.

16. An electronic communication system configured to detect a presence of communication session participants on a network, wherein said communication session participants are included within an authorized list of potential communication session participants; to represent detected communication session participants as graphical activatable icons arranged throughout a three-dimensional environment; and to dynamically animate said graphical activatable icons responsive to detected events associated with said communication session participants.

17. The electronic communication system of claim 16, wherein said electronic communication system is a chat client.

18. The electronic communication system of claim 17, further configured to focus a messaging window of said chat client for communicating with one of said detected communication session participants represented by said selected graphical activatable icon, responsive to a selection of one of said graphical activatable icons.

19. A chat client graphical user interface comprising:
a single messaging display area having a plurality of selectable tabs, wherein each tab is associated with a particular ongoing chat session, wherein selection of any one of said tabs causes said messaging display area to display only chat communications associated with said ongoing chat session represented by said selected tab.

20. A machine-readable storage, having stored thereon a computer program having a plurality of code sections executable by a machine for causing the machine to perform the steps of:
detecting a presence of communication session participants on a computer network, wherein said communication session participants are included within an authorized list of potential communication session participants;
representing detected communication session participants as graphical activatable icons arranged throughout a pictorial environment; and
dynamically animating said graphical activatable icons responsive to events associated with said communication session participants.

21. The machine-readable storage of claim 20, wherein said electronic communication system is a chat client.

22. The machine-readable storage of claim 21, wherein said event is a change in a status of said presence of one of said communication session participants on said computer network.

23. The machine-readable storage of claim 22, wherein said event is selected from the group consisting of one of said communication session participants logging onto said computer network, one of said communications session participants logging off of said computer network, receiving a communication from one of said communication session participants, and sending a communication to one of said communication session participants.

24. The method of claim 22, wherein said event is selected from the group consisting of not receiving a communication from one of said communication session participants for a predetermined period of time, one of said communication session participants selecting an online emotional state, and one of said communication session participants selecting an online status indicator.

25. The machine-readable storage of claim 21, wherein said pictorial environment is a three-dimensional environment.

26. The machine-readable storage of claim 25, further comprising:
responsive to a selection of one of said graphical activatable icons, focusing a messaging window of said chat client for communicating with one of said detected chat session participants represented by said selected graphical activatable icon.

27. The machine-readable storage of claim 26, further comprising:
displaying a graphical user interface, for receiving message text to be sent to one of said communication session participants, as an attachment to a utility bar of an operating system.

28. The machine-readable storage of claim 27, further comprising:
locating an activatable icon utility proximate to said selected activatable icon.

29. The machine-readable storage of claim 28, wherein said activatable icon utility and said pictorial environment are contained within a first display window of said chat client which is distinct from said messaging window of said chat client.

30. A machine-readable storage, having stored thereon a computer program having a plurality of code sections executable by a machine for causing the machine to perform the steps of:
receiving chat messages associated with a plurality of chat sessions;
identifying chat messages associated with a selected one of said plurality of chat sessions; and
displaying said selected chat session within a messaging portion of a chat client interface.

31. The machine-readable storage of claim 30, wherein said identifying step and said displaying step are responsive to receiving a chat message associated with said selected chat session.

32. The machine-readable storage of claim 30, further comprising:
providing activatable icons for each of said plurality of chat sessions; and
visually distinguishing one of said activatable icons representing said selected chat session from other ones of said activatable icons.

33. The machine-readable storage of claim 30, further comprising:
providing activatable icons for each of said plurality of chat sessions, wherein said identifying step and said displaying step are responsive to a user selection of one of said activatable icons representing said selected chat session.

34. The machine-readable storage of claim 30, further comprising:
responsive to a selection of another one of said activatable icons, displaying within said messaging portion of said chat client only those chat messages associated with said chat session represented by said selected another one of said activatable icons.
